(19) United States
(12) Patent Application Publication
(10) Pub. No.: US 2009/0003379 A1
(43) Pub. Date: Jan. 1, 2009

(54) SYSTEM AND METHOD FOR WIRELESS COMMUNICATION OF UNCOMPRESSED MEDIA DATA HAVING MEDIA DATA PACKET SYNCHRONIZATION

(75) Inventors: Huai-Rong Shao, San Jose, CA (US); Chiu Ngo, San Francisco, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Suwon City (KR)

(21) Appl. No.: 11/769,636

(22) Filed: Jun. 27, 2007

(51) Int. Cl. H04J 3/16

(52) U.S. Cl. 370/466

(57) ABSTRACT

A system and method for wireless communication of uncompressed media data having media data packet synchronization are disclosed. One embodiment of the system includes a source configured to transmit media data packets such that they propagate over a wireless channel and at least one sink configured to receive the media data packets over the wireless channel from the source. The media data packets are spaced apart from one another by at least one interleaved time. The system is configured to detect propagation of the media data packets, and to determine propagation delays of the media data packets. The source is further configured to determine a jitter between the media data packets based on the determined propagation delays. The source is further configured to adjust the transmission of the media data packets in response to the determination of the jitter.

### BACKGROUND OF THE INVENTION

1. Field

The present invention relates to transmission of media data, and in particular, to transmission of uncompressed media data over wireless channels.

2. Description of the Related Technology

With the proliferation of high quality video, an increasing number of electronic devices, such as consumer electronic devices, utilize high definition (HD) video which can require about 1 to several Gbps (gigabits per second) in bandwidth for transmission. As such, when transmitting such HD video between devices, conventional transmission approaches compress the HD video to a fraction of its size to lower the required transmission bandwidth. The compressed video is then decompressed for consumption. However, with each compression and subsequent decompression of the video data, some data can be lost and the picture quality can be reduced.

The High-Definition Multimedia Interface (HDMI) specification allows transfer of uncompressed HD signals between devices via a cable. While consumer electronics makers are beginning to offer HDMI-compatible equipment, there is not yet a suitable wireless (e.g., radio frequency) technology that is capable of transmitting uncompressed HD video signals. Wireless local area network (WLAN) and similar technologies can suffer interference issues when several devices which do not have the bandwidth to carry the uncompressed HD signals are connected to the network.

Wireless transfer of uncompressed media data can involve transmission of data packets in at least one data stream. Data packets can be transmitted such that they are spaced apart from one another by predetermined intervals. The intervals, however, may change while the data packets are being processed at a transmitter and/or a receiver, or transmitted over a wireless channel. Data packet synchronization refers to synchronizing such data packets with one another when played back at a single sink device or multiple sink devices. There is a need to provide a system and a method which allows effective synchronization of wirelessly transmitted data packets while minimizing burden on wireless channel capacity.

### SUMMARY OF CERTAIN INVENTIVE ASPECTS

One inventive aspect is a method of wireless communication of uncompressed media data. The method comprises: transmitting media data packets from a source such that they propagate over a wireless channel, the media data packets being spaced apart from one another by at least one interleaved time; detecting propagation of at least two of the media data packets; determining propagation delays of the at least two media data packets; determining a jitter value between the at least two media data packets based on the determined propagation delays; and adjusting the transmission of subsequent media data packets from the source at least partly in response to the determination of the jitter value.

The media data may comprise at least one of audio data and video data. The media data packets may be transmitted in a single data stream from the source to a sink over the wireless channel, and determining the jitter value may comprise determining a variance in the propagation delays between the media data packets in the single data stream. The media data packets may be transmitted in at least two data streams from the source to at least one sink, and determining the jitter value may comprise determining a variance in the propagation delays between the media data packets in the at least two data streams. The at least two data streams may comprise a video data stream and an audio data stream, and the at least one sink may comprise a video sink configured to receive the video data stream and an audio sink configured to receive the audio data stream. The at least two data streams may comprise a plurality of audio data streams, and the at least one sink may comprise a plurality of audio sinks, each configured to receive a corresponding one of the audio data streams. One of the at least two data streams may be a master stream and the others of the at least two data streams may be slave streams, and adjusting the transmission of the subsequent media data packets may comprise synchronizing the slave streams to the master stream.

The source may comprise a transmitter configured to process the media data packets and to send the media data packets over the wireless channel. The sink may comprise a receiver configured to receive the media data packets over the wireless channel and to process the received media data packets. Detecting the propagation of the at least two media data packets may comprise detecting the propagation of the at least two media data packets while the at least two media data packets propagate through at least part of the transmitter, the wireless channel, and the receiver.

The transmitter may comprise an application layer, a media access control (MAC) layer, and a physical (PHY) layer, and detecting the propagation of the at least two media data packets may comprise detecting a first time when each of the at least two media data packets is moved from the transmitter application layer to the transmitter MAC layer. Detecting the propagation of the at least two media data packets may further comprise detecting a second time when each of the at least two media data packets is moved from the PHY layer to the wireless channel. Determining the propagation delays may comprise determining a time difference between the first and second times for each of the at least two media data packets.

The receiver may comprise a physical (PHY) layer, a media access control (MAC) layer, and an application layer, and detecting the propagation of the at least two media data packets may further comprise detecting a second time when each of the at least two media data packets is moved from the receiver MAC layer to the receiver application layer. The method may further comprise sending data indicative of the second time from the receiver to the transmitter such that the propagation delays are determined at the transmitter. Sending the data indicative of the second time may comprise sending an acknowledgment signal from the receiver to the transmitter, and the acknowledgment signal may include the data indicative of the second time.

The method may further comprise adding a time stamp indicative of the first time to each of the at least two media data packets at the transmitter before the data packets are transmitted to the receiver. The propagation delays may be determined at the receiver using the time stamp, and the method may further comprise sending data indicative of the propagation delays from the receiver to the transmitter. Sending the data indicative of the propagation delays may comprise sending an acknowledgment signal from the receiver to the transmitter, and the acknowledgment signal may include the data indicative of the propagation delays. Sending the data indicative of the propagation delays may comprise selectively sending the data indicative of the propagation delays only when the propagation delays exceed a threshold value.

The jitter value may be determined at the source. Adjusting the transmission of the subsequent media data packets may comprise re-synchronizing the subsequent media data packets if the jitter value exceeds a predetermined value.

Another inventive aspect is a wireless communication system of uncompressed media data comprising: a source configured to transmit media data packets such that they propagate over a wireless channel, the media data packets being spaced apart from one another by at least one interleaved time; and at least one sink configured to receive the media data packets over the wireless channel from the source, wherein at least one of the source and the at least one sink is configured to detect propagation of at least two of the media data packets, and to determine propagation delays of the at least two media data packets, wherein the source is configured to determine a jitter value between the at least two media data packets based on the determined propagation delays, and wherein the source is further configured to adjust the transmission of subsequent media data packets at least partly based on the jitter value.

The source may comprise a transmitter configured to transmit the media data packets in a single data stream, and the source may be configured to determine the jitter value by determining a variance in the propagation delays between the media data packets in the single data stream. The source may comprise a transmitter configured to transmit the media data packets in at least two data streams, and the source may be configured to determine the jitter value by determining a variance in the propagation delays between the media data packets in the at least two data streams.

The source may comprise a transmitter configured to process the media data packets and to send the media data packets over the wireless channel, wherein the at least one sink may comprise a receiver configured to receive the media data packets over the wireless channel and to process the received media data packets, and wherein the system is configured to detect the propagation of the at least two media data packets while the media data packets propagate through at least part of the transmitter, the wireless channel, and the receiver.

The transmitter may comprise an application layer, a media access control (MAC) layer, and a physical (PHY) layer, and the transmitter may be configured to detect a first time when each of the at least two media data packets is moved from the transmitter application layer to the transmitter MAC layer. The transmitter may be further configured to detect a second time when each of the at least two media data packets is moved from the transmitter PHY layer to the wireless channel. The transmitter may be further configured to determine a time difference between the first and second times for each of the at least two media data packets, thereby determining the propagation delays.

The receiver may comprise a physical (PHY) layer, a media access control (MAC) layer, and an application layer, and the receiver may be configured to detect a second time when each of the at least two media data packets is moved from the receiver MAC layer to the receiver application layer. The receiver may be further configured to send data indicative of the second time to the transmitter, and the transmitter may be further configured to determine the propagation delays. The receiver may be further configured to send an acknowledgment signal to the transmitter, and the acknowledgment signal may include the data indicative of the second time.

The transmitter may be further configured to add a time stamp indicative of the first time to each of the at least two media data packets before the data packets are transmitted to the receiver. The receiver may be further configured to determine the propagation delays using the time stamp, and to send data indicative of the propagation delays to the transmitter. The receiver may be further configured to send an acknowledgment signal to the transmitter, and the acknowledgment signal may include the data indicative of the propagation delays. The receiver may be further configured to selectively send the data indicative of the propagation delays only when the propagation delays exceed a threshold value. The source may be configured to re-synchronize subsequent media data packets if the jitter value exceeds a predetermined value.

Yet another inventive aspect is a wireless communication device for transmitting uncompressed media data, the device comprising: a transmitter configured to process media data to generate media data packets which are spaced apart from one another by at least one interleaved time, and transmit the media data packets such that they propagate over a wireless channel; wherein the transmitter is further configured to at least partially detect propagation of at least two of the media data packets to determine propagation delays of the media data packets; and wherein the transmitter is further configured to determine a jitter value between the at least two media data packets based on the determined propagation delays, and to adjust the transmission of subsequent media data packets at least partly in response to the determination of the jitter value.

The transmitter may comprise an application layer, a media access control (MAC) layer, and a physical (PHY) layer, and the transmitter may be configured to detect a first time when each of the at least two media data packets is moved from the transmitter application layer into the transmitter MAC layer. The transmitter may be further configured to detect a second time at the transmitter when each of the at least two media data packets is moved from the PHY layer to the wireless channel.

Another inventive aspect is a wireless communication device for receiving uncompressed media data. The device comprises a receiver configured to receive media data packets which are spaced apart from one another by at least one interleaved time over a wireless channel from a transmitter, and to process the media data packets to recover media data; wherein the receiver is further configured to at least partially detect propagation of at least two of the media data packets for determining propagation delays of the media data packets; and wherein the receiver is further configured to send data indicative of the propagation delays of the at least two media data packets over the wireless channel to the transmitter.

The receiver may comprise a physical (PHY) layer, a media access control (MAC) layer, and an application layer, and the receiver may be configured to detect an arriving time when each of the at least two media data packets is moved from the MAC layer to the application layer. The data may be indicative of the second time. The at least two media data packets may include time stamps indicative of the starting time of the propagation of the at least two data packets, and the receiver may be further configured to determine the propagation delays using the time stamps, and to send data indicative of the propagation delays to the transmitter.

### BRIEF DESCRIPTION OF THE DRAWINGS

FIG. 1 is a functional block diagram of a wireless network that implements uncompressed HD video transmission between wireless devices, according to one embodiment of the system and method.

FIG. 2 is a functional block diagram of an example communication system for transmission of uncompressed HD video over a wireless medium, according to one embodiment of the system and method.

FIG. 3 is a functional block diagram of an example transmitter for transmission of uncompressed HD video over a wireless medium, according to one embodiment of the system and method.

FIG. 4 is a functional block diagram of an example receiver for receipt of uncompressed HD video over a wireless medium, according to one embodiment of the system and method.

FIG. 5A is a diagram illustrating a low rate (LR) channel for uncompressed HD video transmission, according to one embodiment.

FIG. 5B is a diagram illustrating a high rate (HR) channel for uncompressed HD video transmission and a low rate (LR) channel for acknowledgment signal transmission, according to another embodiment.

FIG. 6 is a timeline for packet transmission using Time Division Duplex (TDD) scheduling, according to one embodiment.

FIG. 7 is a functional block diagram of an example communication system for transmission of data packets in a single data stream over a wireless channel, according to one embodiment.

FIGS. 8A and 8B are timing diagrams illustrating intra-stream jitters occurring in transmission of data packets over a wireless channel.

FIGS. 9A and 9B are functional block diagrams of example communication systems for transmission of data packets in multiple data streams over wireless channels, according to other embodiments.

FIGS. 10A and 10B are timing diagrams illustrating inter-stream jitters occurring in transmission of data packets over wireless channels.

FIG. 11 is a flowchart illustrating a method of synchronizing data packet transmission over a wireless channel, according to one embodiment.

FIG. 12A is a flowchart illustrating a method of synchronizing data packet transmission over a wireless channel, according to another embodiment.

FIG. 12B is a flowchart illustrating a method of synchronizing data packet transmission over a wireless channel, according to yet another embodiment.

FIG. 12C is a flowchart illustrating a method of synchronizing data packet transmission over a wireless channel, according to yet another embodiment.

FIG. 13 is a frame format of an acknowledgment signal for use in synchronizing data packet transmission over a wireless channel according to one embodiment.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements.

Certain embodiments provide a method and system for transmission of uncompressed HD video information from a sender to a receiver over wireless channels. Example implementations of the embodiments in a wireless high definition (HD) audio/video (A/V) system will now be described.

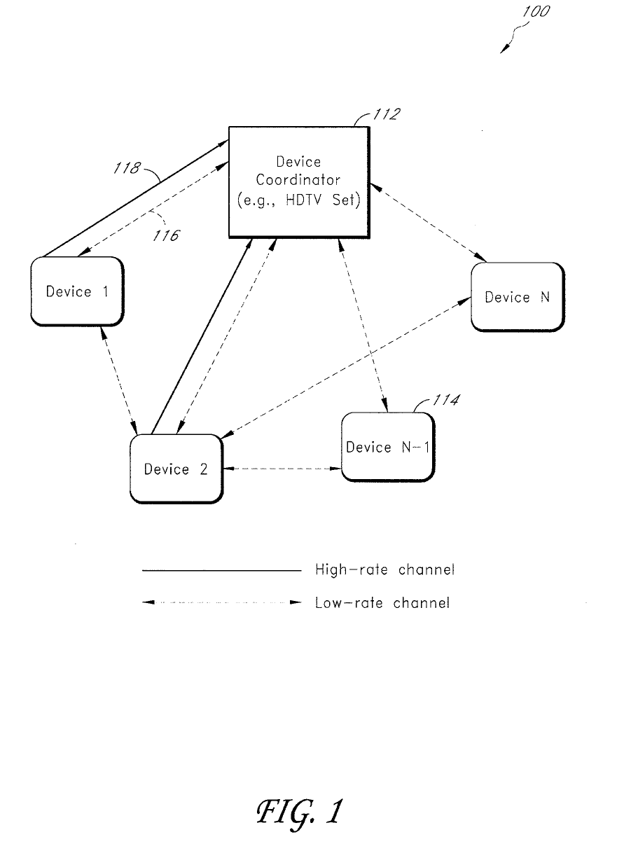

FIG. 1 shows a functional block diagram of a wireless network 100 that implements uncompressed HD video transmission between A/V devices such as an A/V device coordinator and A/V stations, according to certain embodiments. In other embodiments, one or more of the devices can be a computer, such as a personal computer (PC). The network 100 includes a device coordinator 112 and multiple A/V stations 114 (e.g., Device 1, . . . , Device N).

The A/V stations 114 utilize a low-rate (LR) wireless channel 116 (dashed lines in FIG. 1), and may use a high-rate (HR) channel 118 (heavy solid lines in FIG. 1), for communication between any of the devices. The device coordinator 112 uses a low-rate wireless channel 116 and a high-rate wireless channel 118 for communication with the stations 114. Each station 114 uses the low-rate channel 116 for communications with other stations 114. The high-rate channel 118 supports single direction unicast transmission over directional beams established by beamforming, with e.g., multi-Gbps bandwidth, to support uncompressed HD video transmission. For example, a set-top box can transmit uncompressed video to a HD television (HDTV) over the high-rate channel 118. The low-rate channel 116 can support bi-directional transmission, e.g., with up to 40 Mbps throughput in certain embodiments. The low-rate channel 116 is mainly used to transmit control frames such as acknowledgment (ACK) frames. For example, the low-rate channel 116 can transmit an acknowledgment from the HDTV to the set-top box. It is also possible that some low-rate data like audio and compressed video can be transmitted on the low-rate channel between two devices directly. Time division duplexing (TDD) is applied to the high-rate and low-rate channels. At any one time, the low-rate and high-rate channels cannot be used in parallel for transmission, in certain embodiments. Beamforming technology can be used in both low-rate and high-rate channels. The low-rate channels can also support omni-directional transmissions.

In one example, the device coordinator 112 is a receiver of video information (hereinafter “receiver 112”), and the station 114 is a sender of the video information (hereinafter “sender 114”). For example, the receiver 112 can be a sink of video and/or audio data implemented, such as, in an HDTV set in a home wireless network environment which is a type of WLAN. The sender 114 can be a source of uncompressed video or audio. Examples of the sender 114 include a set-top box, a DVD player or recorder, digital camera, camcorder, and so forth.

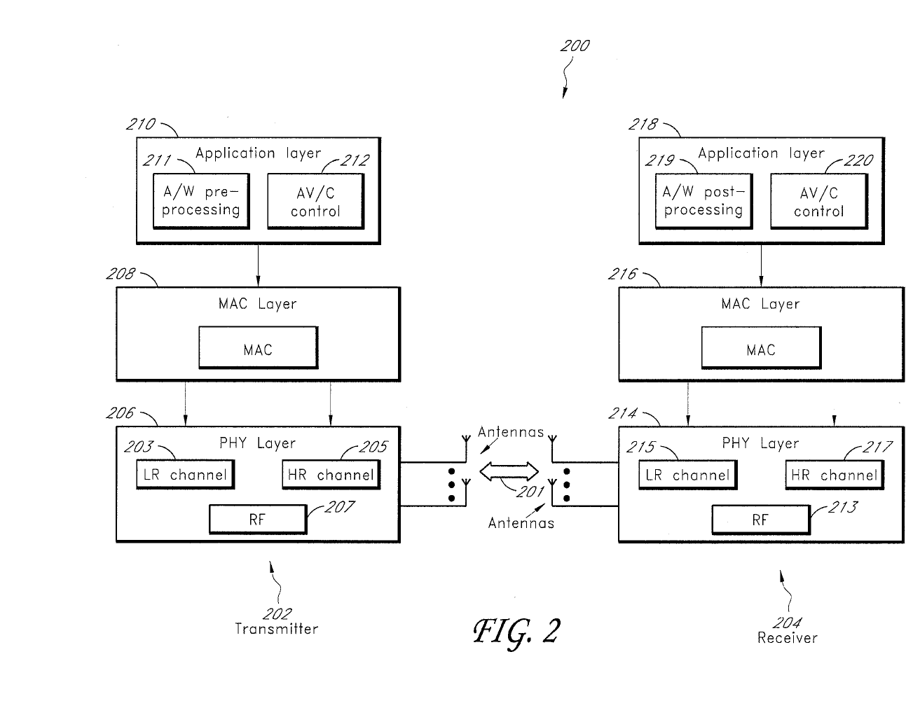

FIG. 2 illustrates a functional block diagram of an example communication system 200. The system 200 includes a wireless transmitter 202 and wireless receiver 204. The transmitter 202 includes a physical (PHY) layer 206, a media access control (MAC) layer 208 and an application layer 210. Similarly, the receiver 204 includes a PHY layer 214, a MAC layer 216, and an application layer 218. The PHY layers provide wireless communication between the transmitter 202 and the receiver 204 via one or more antennas through a wireless medium 201.

The application layer 210 of the transmitter 202 includes an A/V pre-processing module 211 and an audio video control (AV/C) module 212. The A/V pre-processing module 211 can perform pre-processing of the audio/video such as partitioning of uncompressed video. The AV/C module 212 provides a standard way to exchange A/V capability information. Before a connection begins, the AV/C module negotiates the A/V formats to be used, and when the need for the connection is completed, AV/C commands are used to stop the connection.

In the transmitter 202, the PHY layer 206 includes a low-rate (LR) channel 203 and a high rate (HR) channel 205 that are used to communicate with the MAC layer 208 and with a radio frequency (RF) module 207. In certain embodiments, the MAC layer 208 can include a packetization module (not shown). The PHY/MAC layers of the transmitter 202 add PHY and MAC headers to packets and transmit the packets to the receiver 204 over the wireless channel 201.

In the wireless receiver 204, the PHY/MAC layers 214, 216 process the received packets. The PHY layer 214 includes a RF module 213 connected to the one or more antennas. A LR channel 215 and a HR channel 217 are used to communicate with the MAC layer 216 and with the RF module 213. The application layer 218 of the receiver 204 includes an A/V post-processing module 219 and an AV/C module 220. The module 219 can perform an inverse processing method of the module 211 to regenerate the uncompressed video, for example. The AV/C module 220 operates in a complementary way with the AV/C module 212 of the transmitter 202.

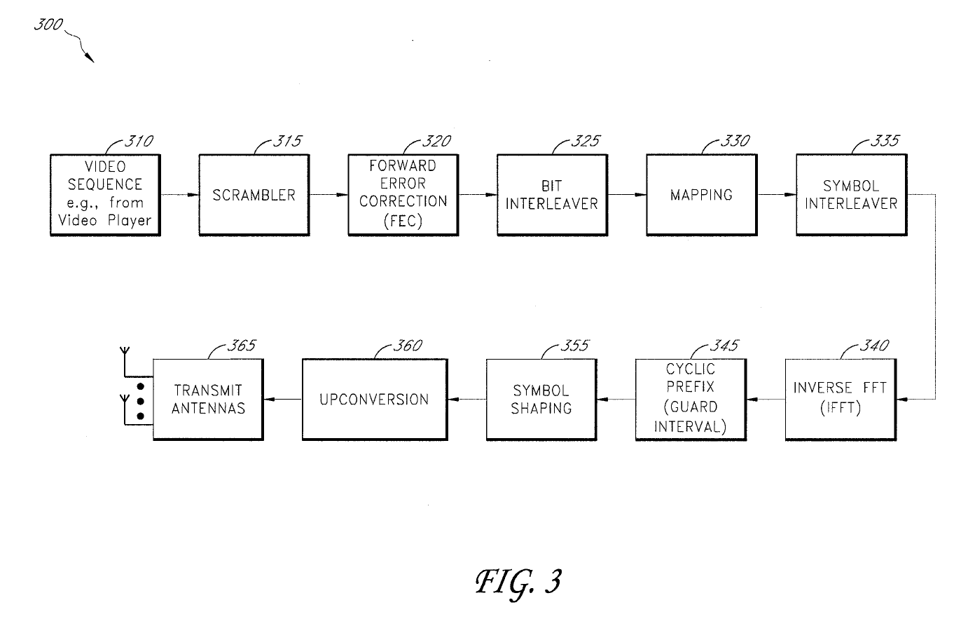

FIG. 3 is a functional block diagram illustrating an example of a transmit chain 300 comprising modules, subsystems or devices, such as used in the PHY block 206 (FIG. 2). It will be appreciated that these modules, subsystems, or devices can be implemented using hardware, software or a combination of both. A video sequence 310 having video data, such as from a video player or other device, is input into a scrambler 315. The scrambler 315 transposes or inverts signals or otherwise encodes data to make the data unintelligible at a receiver not equipped with a corresponding descrambling device. Scrambling is accomplished by the addition of components to the original signal or the changing of some important component of the original signal in order to make extraction of the original signal difficult. Examples of the latter can include removing or changing vertical or horizontal sync pulses in video signals.

A forward error correction (FEC) subsystem 320 receives output from the scrambler and provides protection against noise, interference and channel fading during wireless data transmission. The FEC subsystem 320 adds redundant data to the scrambled video data input to the subsystem. The redundant data allows the receiver to detect and correct errors without asking the transmitter for additional data. In adding redundant data to the video data, the FEC subsystem 320 can use various error correction codes, such as a Reed-Solomon (RS) encoder and a convolutional code (CC) encoder. In other embodiments, the FEC subsystem 320 may use various other encoders, including, but not limited to, a LDPC encoder, a Hamming encoder, and a Bose, Ray-Chaudhuri, Hocquenghem (BCH) encoder.

The output of the FEC 320 is sent to a bit interleaver 325. The bit interleaver 325 rearranges a sequence of data bits received from the FEC 320. The bit interleaver 325 serves to provide further error-protection over video data transmitted over a wireless medium. The output of the bit interleaver 325 is sent to a mapper 330. The mapper 330 maps data bits to complex (IQ) symbols. The complex symbols are used to modulate a carrier for the wireless transmission described above. The mapper 330 can use various modulation schemes, including, but not limited to, Binary Phase-Shift Keying (BPSK), Quadrature Phase-Shift Keying (QPSK), and Quadrature Amplitude Modulation (QAM). In one embodiment, the mapper 330 is a QAM mapper, for example, a 16-QAM mapper or 64-QAM mapper. QAM is a modulation scheme which conveys data by modulating the amplitude of two carrier waves. The two waves, usually two orthogonal sinusoids, are out of phase with each other by 90° and thus are called quadrature carriers. The number, 16 or 64, in front of “QAM” refers to the total number of symbols to which the mapper can map groups of data bits. For example, a 16-QAM mapper converts 4-bit data into 2̂4=16 symbols. Typically, for QAM mappers, a constellation diagram is used for representing the collection of such symbols.

The output of the mapper 330 is sent to a symbol interleaver 335 that rearranges the sequence of complex symbols output from the mapper. The illustrated symbol interleaver 335 is positioned after the mapper 330. In other embodiments, the symbol interleaver 335 may be positioned between the FEC and the mapper 330 in place of the bit interleaver. In such embodiments, the symbol interleaver permutes the predetermined number of bits as a symbol group. For example, in an embodiment where a QAM mapper maps four data bits to a complex symbol, the symbol interleaver is configured to interleave groups of four data bits.

In an embodiment where the symbol interleaver 335 is positioned after the mapper 330, the symbol interleaver rearranges the sequence of the symbols output from the mapper 330. In one embodiment, the symbol interleaver 335 can include a random interleaver which employs a fixed random permutation order and interleaves symbols according to the permutation order. For example, the random interleaver may use Radix-2 FFT (fast fourier transform) operation. In other embodiments, the symbol interleaver 335 can include a block interleaver. A block interleaver accepts a set of symbols and rearranges them without repeating or omitting any of the symbols in the set. The number of symbols in each set is fixed for a given interleaver. The interleaver's operation on a set of symbols is independent of its operation on all other sets of symbols.

The output of the symbol interleaver 335 is sent to an inverse Fast Fourier Transform (IFFT) module 340. The IFFT 340 transforms frequency domain data from the error-correcting, mapping and interleaving modules back into corresponding time domain data. The IFFT module 340 converts a number of complex symbols, which represent a signal in the frequency domain, into the equivalent time domain signal. The IFFT module 340 also serves to ensure that carrier signals produced are orthogonal. The output of the IFFT 340 is sent to a cyclic prefix adder 345 so as to decrease receiver complexity. The cyclic prefix adder 345 may also be referred to as a guard interval inserter. The cyclic prefix adder 345 adds a cyclic prefix interval (or guard interval) to an IFFT-processed signal block at its front end. The duration of such a cyclic prefix interval may be 1/32, 1/16, ⅛, or ¼ of the original signal block duration, depending on realistic channel conditions and affordable receiver complexity.

At this point of the transmit chain 300, a preamble is part of the header 310 and prior to the IFFT-processed signal block. Generally, a preamble is selected by the designers of the system 200, such as previously described, and is standardized so that all devices of the system understand it. The use of preamble is to detect start of the packet, estimate various channel parameters, such as symbol timing, carrier frequency offset so that data reception can be done successfully.

A symbol shaping module 355 interpolates and low-pass filters the packet signal generated from the IFFT module 340, the cyclic prefix adder 345 and the preamble. The output of the symbol shaping module 355 is a complex baseband of the output signal of the IFFT module 340. An upconverter 360 upconverts the output of the symbol shaping module 355 to a radio frequency (RF) for possible meaningful transmission. A set of transmit antennas 365 transmit the signal output from the upconverter 360 over a wireless medium, such as the wireless channel 201 (FIG. 2) to a receiver. The transmit antennas 365 can include any antenna system or module suitable for wirelessly transmitting uncompressed HD video signals.

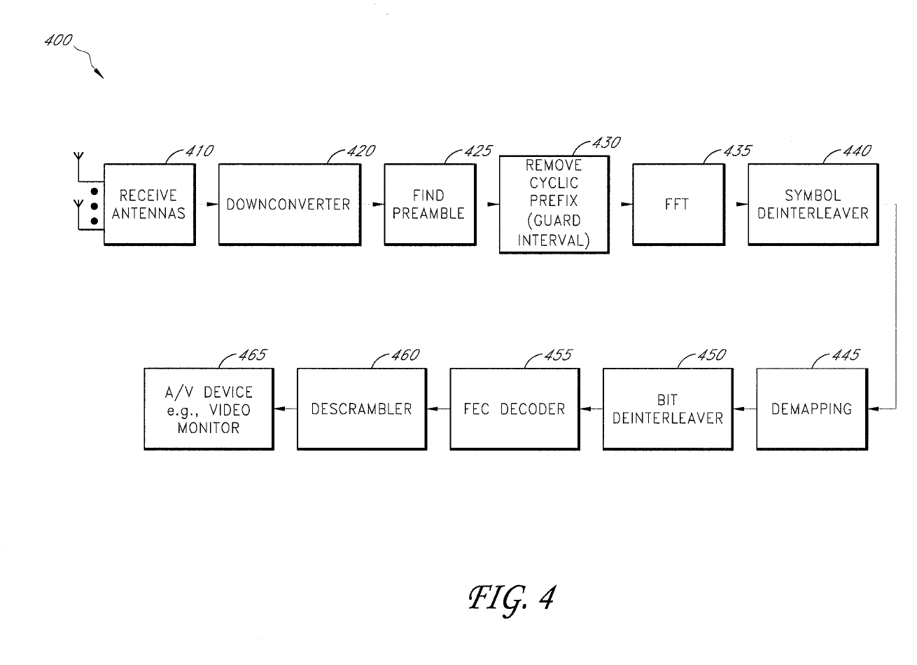

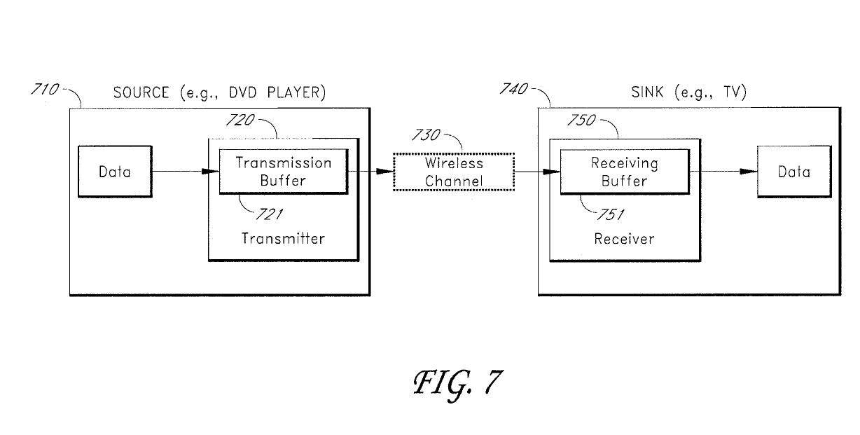

FIG. 4 is a functional block diagram illustrating a receiver chain 400 of modules, subsystems or devices, such as used in the PHY block 214 (FIG. 2). The receiver chain 400 generally performs an inverse process of that of the transmitter chain 300 of FIG. 3. The receiver 400 receives an RF signal via the wireless channel 201 (FIG. 2) at receive antennas 410 from the transmit antennas 365 of the transmitter chain 300. A downconverter 415 downconverts the RF signal to a signal of a frequency suitable for processing, or the baseband signal, which is already in the digital domain for easy digital signal processing. A preamble finder 420 then locates a preamble portion of the digital signal, finds the symbol starting timing, estimates the channel coefficients, estimates the carrier frequency offset and tries to compensate it via local processing. In certain embodiments, the preamble finder 420 includes a correlator and a packet start finding algorithm that can operate on the short training sequences of the preamble (FIGS. 4 and 7). After the preamble is identified by the finder 420, the preamble portion of a current signal packet is sent to a channel estimation, synchronization and timing recovery component 425, which will be further described below. A cyclic prefix remover 430 removes the cyclic prefix from the signal. Next, a fast Fourier transform (FFT) module 435 transforms the signal (a time-domain signal) into a frequency-domain signal. The output of the FFT 435 is used by a symbol deinterleaver 440 which rearranges the FFT output for a demapper 445. The demapper 445 converts the frequency-domain signal (a complex signal) into a bit stream in the time domain. A bit deinterleaver 450 rearranges the bit stream in the original bit stream sequence as before the bit interleaver 325 of FIG. 3.

Subsequently to the bit deinterleaving, a FEC decoder 455 decodes the bit stream, thereby removing redundancy added by the FEC 320 of FIG. 3. In one embodiment, the FEC decoder 455 includes a demultiplexer, a multiplexer, and a plurality of convolutional code (CC) decoders interposed between the demultiplexer and the multiplexer. Finally, a descrambler 460 receives the output from the FEC decoder 455, and then descrambles it, thereby regenerating the video data sent from the transmitter chain 300 of FIG. 3. A video device 465 can now display video using the video data. Examples of the video device include, but are not limited to, a CRT television, an LCD television, a rear-projection television and a plasma display television. It will be appreciated that audio data can also be processed and transmitted in the same manner along with video data by the wireless HD A/V system described above. The audio data can be processed and transmitted using a different wireless transmission scheme. The descrambler 460, FEC decoder 455, bit deinterleaver 450, demapper 445, symbol deinterleaver 440, FFT 435 cyclic prefix remover 430, down-converter 415 and receive antennas 410 of the receiver chain 400 perform analogous but inverse functions of the corresponding scrambler 315, FEC 320, bit interleaver 325, mapper 330, symbol interleaver 335, IFFT 340, cyclic prefix adder 345, upconverter 360 and transmit antennas 365 of the transmit chain 300.

Video signals can be represented by pixel data that encodes each pixel as several values, e.g., using a RGB color model (red, green, and blue), or a YUV (one luminance and two chrominance values). Generally, viewers are more sensitive to transmission errors or loss of data in the most significant bits (MSB) of pixel values than to errors or loss in the least significant bits (LSB) of pixel values. Thus, in one embodiment, the MSB of each pixel value (e.g. 4 out of 8 bits per color channel) is encoded with a more robust coding and/or modulation scheme than for the remaining LSB of each pixel value.

As described above with reference to FIG. 1, the wireless HD A/V system can include a low-rate (LR) channel and a high-rate (HR) channel according to one embodiment. The two channels operate in time-division duplex (TDD) mode, i.e., only one channel can be activated at any given instance.

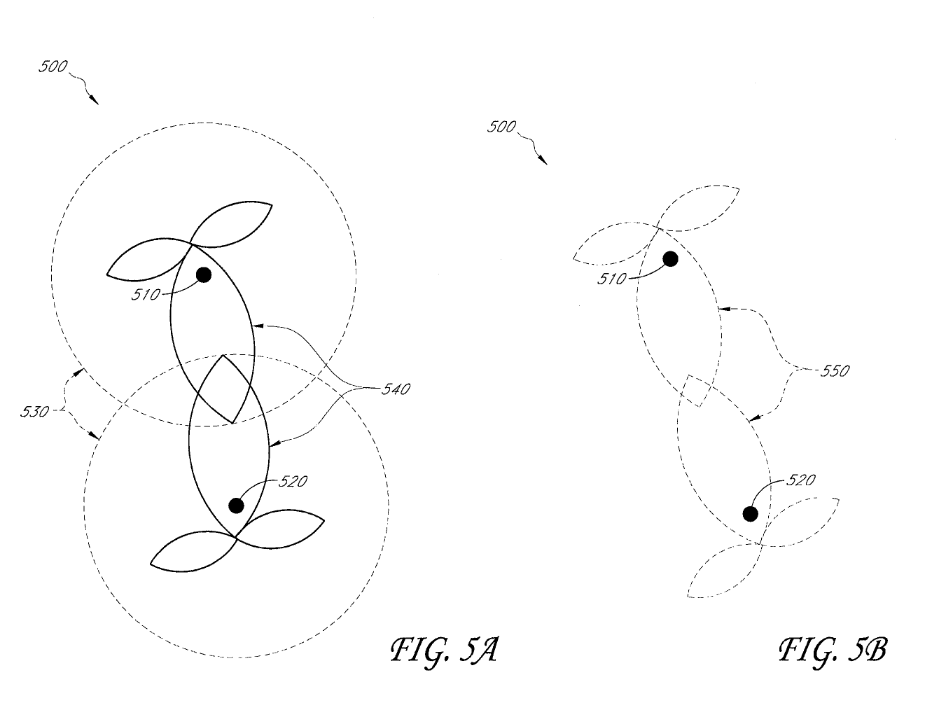

FIG. 5A is a diagram illustrating a low-rate (LR) channel established between two devices in the wireless system 500 according to one embodiment. Examples of the devices include, but are not limited to, a DVD player, an HD television, a home theater device, a media server, a printer, and an overhead projector. The illustrated system 500 includes a display device 510 (e.g., HD television, an overhead projector, etc.) and a video source device 520 (e.g., a set-top box (STB), a DVD player, a VCR, a TiVo® recorder, etc.). In the illustrated embodiment, the video source device 520 is a sender of video data whereas the display device 510 is a receiver. In other embodiments, if a high rate channel between the devices 510, 520 is symmetric, the video source device 520 may also operate as a receiver whereas the display device 510 serves as a sender depending on the direction of data transmission. For example, the display device 510 (e.g., an HD television) may receive broadcast video data and send it to the video source device 520 (e.g., a DVD recorder) for storing the video data.

The LR channel is a symmetric control channel. The LR channel may operate in two modes: omni-directional mode 530 and directional (beam-formed) mode 540.

The omni-directional mode 530 is used for transmission of control data such as beacon, association and disassociation, device discovery, and the like. The omni-directional mode 530 can support a data rate of about 2.5 to about 10 Mbps. The omni-directional mode 530 can be established using any suitable omni-directional antennas. The omni-directional antennas are configured to radiate power substantially uniformly in all directions. Examples of the omni-directional antennas include, but are not limited to, a whip antenna, a vertically oriented dipole antenna, a discone antenna, and a horizontal loop antenna.

The directional mode 540 can be used for transmitting some control data (e.g., acknowledgment (ACK)), and low-volume data (e.g., audio data). The directional mode 540 may support a data rate of about 20 to about 40 Mbps. The directional mode 540 can be established by forming a beam between the two devices 510, 520 in the system. It will be appreciated that any suitable directional antennas can be adapted for beam-forming. A skilled technologist will appreciate that various communication technologies can be adapted for implementing the directional or omni-directional modes.

FIG. 5B is a diagram illustrating an asymmetric directional channel 550 established between a display device 510 (e.g., a digital TV (DTV)) and a video source device 520 (e.g., a set-top box (STB), a DVD player (DVD)) in the wireless system 500 according to one embodiment. The directional channel can include a high rate (HR) channel and a low rate (LR) channel. The channel 550 can be established by forming a beam between the devices 510, 520. The HR channel can be used for transmission of uncompressed video data from the video source device 520 to the display device 510. The HR channel may support a data rate of about 1 to about 4 Gbps. The packet transmission duration on the HR channel can be about 100 μs to about 300 μs. In the illustrated embodiment, the display device 510 can send ACK to the video source device 520 via the LR channel after receiving video data from the video source device 520.

In one embodiment, the wireless communication system 500 is configured to wirelessly transmit uncompressed HD television signals. The wireless communication system 500 can use 60 GHz-band millimeter wave technology to transmit signals at a rate of about 1 to about 4 Gbps. The wireless system 500 can use the high-rate (HR) directional channel for transmitting/receiving HD signals. The system 500 may support 1080p HD formats which requires a raw data rate of 2.98 Gbps (frame size x the number of frames per second=(1920×1080×3×8)×60).

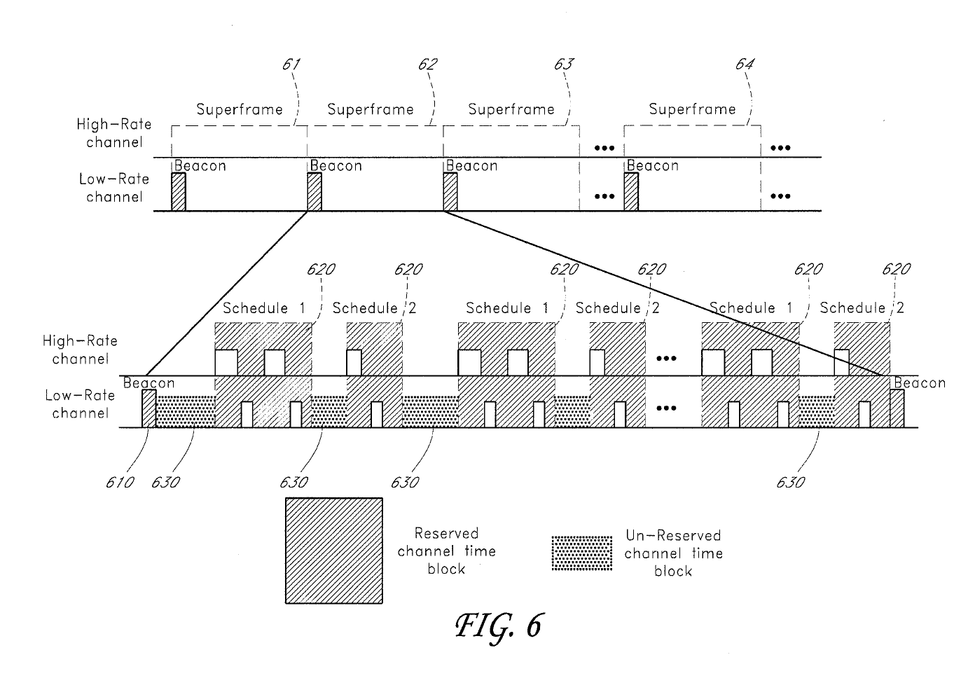

In one embodiment, the wireless HD A/V system described above can use a data transmission timeline shown in FIG. 6 for wireless communication between two devices in the system. One of the devices in the system can act as a controller which is responsible for managing superframes 61-64. In the illustrated embodiment, a video data sender may serve as a controller. Each of the superframes 61-64 includes a beacon frame 610, reserved channel time blocks (CTBs) 620, and unreserved channel time blocks (CTBs) 630. The beacon frame 610 is used to set the timing allocations and to communicate management information for the wireless system. The reserved channel time blocks 620 are used to transmit commands, isochronous streams, and asynchronous data connections. Each of reserved channel time blocks 620 can have single or multiple data frames. Data packets can be transmitted over the high-rate channel in the reserved channel time blocks 620. Acknowledgment signals (with or without beam-forming tracking data) can be transmitted over the low-rate channels. As shown in FIG. 6, only one of the two channels can be used for transmission at a given time. The unreserved channel time blocks 630 can be used to transmit CEC commands and MAC control and management commands on the low-rate channel. Beamforming transmission may not be allowed within the unreserved channel time blocks 630.

### Data Packet Synchronization for Wireless Transmission

FIG. 7 is a schematic block diagram illustrating a wireless media data transmission system 700 according to one embodiment. The system 700 includes a source 710 and a sink 740 which can be linked to each other via a wireless channel 730. The source 710 can include a transmitter 720 for transmitting data. The sink 740 can include a receiver 750 for receiving data. The transmitter 720 is configured to process media data into data packets suitable for transmission over the wireless channel 730. The term “media data” refers to at least one of audio and video data. The video data can include any type of data for displaying moving images, still images, animation, or graphic images. Then, the transmitter 720 sends the data packets over the wireless channel 730 to the receiver 750 of the sink 740. Then, the receiver 750 converts the transmitted data packets back into the original media data so as to allow the sink 740 to play back the media data.

In one embodiment, the source 710 can be a DVD player or a set-top box. The sink 740 can be a display device (e.g., HDTV) or an audio player (e.g., amplifier). It will be appreciated that the source 710 and the transmitter 720 can be separate from each other. It will also be appreciated that the sink 740 and the receiver 750 can be separate from each other. It will also be appreciated that a wireless device can include both a transmitter and a receiver, and function either as a sink or as a source depending on the direction of data transmission.

The transmitter 720 and the receiver 750 can include a transmission buffer 721 and a receiving buffer 751, respectively. These buffers 721, 751 serve to temporarily store data packets before or after processing the data packets. The buffers 721, 751 can have a relatively small capacity, and thus can only temporarily store outgoing or incoming data packets.

In one embodiment, the wireless system 700 is configured to send a high volume of uncompressed media data from the source 710 to the sink 740 via the wireless channel 730. Because the receiver 750 has a limited buffer capacity relative to the high volume of the uncompressed data, the receiver 750 may supply the media data substantially continuously to the sink 740 for playback with limited timing correction.

In such an embodiment, data packet synchronization can be one of the critical factors which affect the quality of media data playback at the sink 740. Certain data packets can be provided to the sink 740 at a predetermined interval. For example, video data packets can be supplied to the sink 740 at a predetermined interval. Similarly, audio data packets can be supplied to an audio sink at a predetermined interval. However, the intervals may change while the data packets are being processed at the transmitter 720 or receiver 750, or being transmitted over the wireless channel 730. In certain instances, interval changes may occur partly because of delays associated with the buffers 751, 741 and the wireless channel 730. These interval changes can cause abrupt discontinuities at playback or mismatches between image and sound.

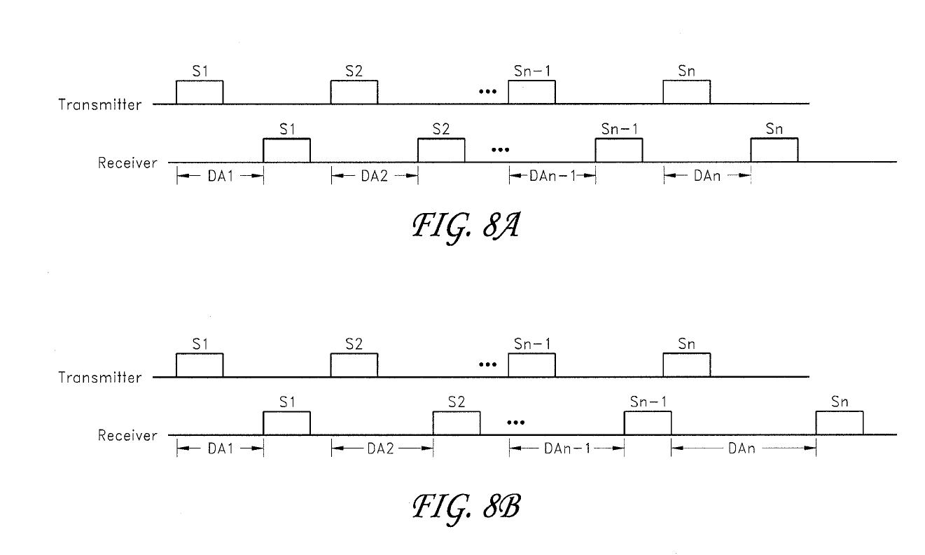

FIG. 8A illustrates a timing diagram of an ideal data packet transmission from a transmitter to a receiver. In FIG. 8A, data packets S1-Sn are sent from the application layer of the transmitter at a given interval. The data packets S1-Sn are processed at the MAC layer and the PHY layer of the transmitter, and then are transmitted over a wireless channel. Then, the data packets S1-Sn arrive at the receiver, and then are processed at the PHY layer and the MAC layer of the receiver. Finally, the data packets S1-Sn are recovered at the application layer of the receiver. As shown in FIG. 8A, the recovered data packets S1-Sn maintain the same intervals (DA1=DA2= . . . =DAn) therebetween as the intervals at the application layer of the transmitter. In reality, however, the intervals may change during the transmission, as shown in FIG. 8B. In FIG. 8B, at least one of the intervals DA1, DA2, . . . , DAn is different from the others. Such an unwanted variation of the intervals between consecutive data packets can be referred to as a “jitter.” A jitter between data packets on a single data stream can be referred to as an “intra-stream jitter.”

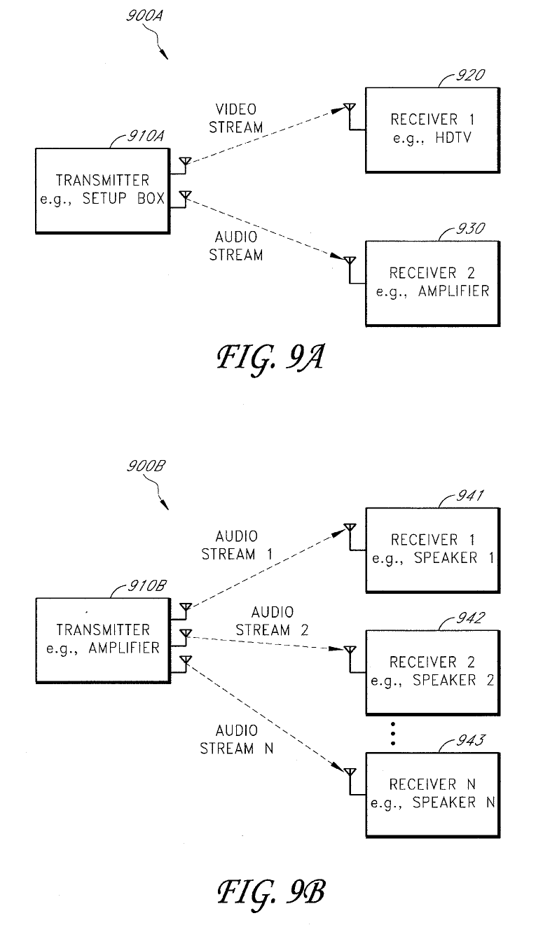

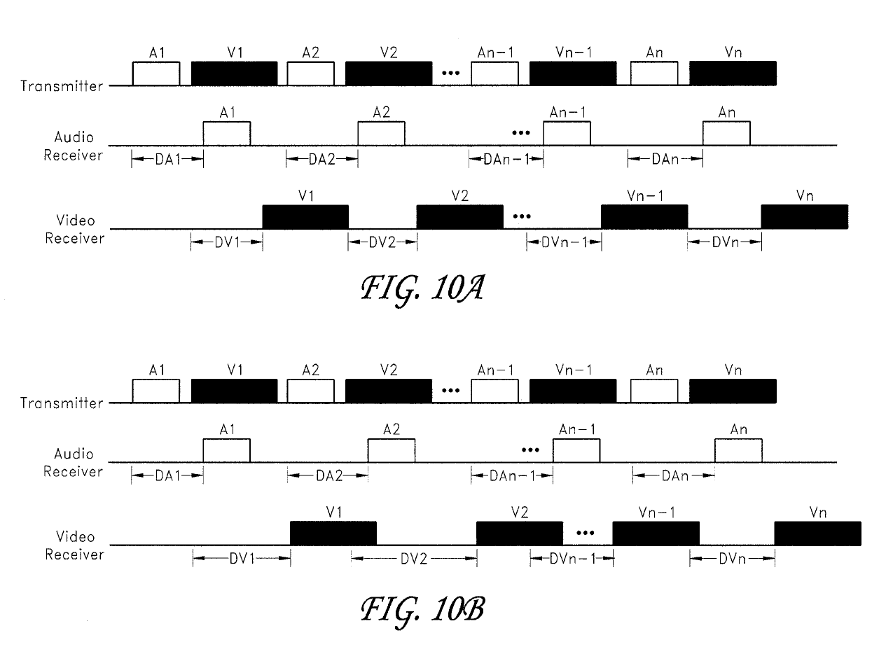

In other embodiments, a transmitter can send multiple data streams to one or more receivers. Referring to FIGS. 9A and 9B, each of wireless media systems 900A, 900B includes a transmitter 910A, 910B and two or more receivers 920, 930, 941-943. For example, in FIG. 9A, the transmitter 910A is a set-top box, and the receivers 920, 930 are an HDTV 920 and an amplifier 930, respectively. The set-top box 910A can send a video stream to the HDTV 920 and an audio stream to the amplifier 930 over wireless channels. In FIG. 9B, the transmitter 910B is an amplifier, and the receivers 941-943 are multiple speakers. The amplifier 910B can send multiple audio streams to the speakers 941-943 over wireless channels. A skilled artisan will appreciate that various other combinations of transmitters and receivers are also possible.

In the embodiments described above in connection with FIGS. 9A and 9B, there is a need to synchronize the multiple data streams at playback at the receivers 920, 930, or 941-943. For example, in the embodiment shown in FIG. 9A, the video and audio streams need lip synchronization at playback at the HDTV 920 and the amplifier 930. Similarly, in the embodiment shown in FIG. 9B, the audio streams need to be synchronized at playback at the speakers 941-943.

FIG. 10A illustrates a timing diagram of an exemplary ideal data packet transmission from a transmitter to a receiver. In the illustrated example, audio data packets A1, A2, . . . , An−1, An, and video data packets V1, V2, . . . , Vn−1, Vn are alternately transmitted from a transmitter to an audio receiver and a video receiver. The audio and video data packets succeed to one another at a predetermined interval at the transmitter (particularly at the application layer of the transmitter). The audio receiver only receives the audio data packets whereas the video receiver only receives the video data packets. Ideally, the data packets arrive at the receivers (particularly, the application layer of each of the receivers) with substantially the same delay, as shown in FIG. 10A. In FIG. 10A, the delays DA1, DA2, . . . , DAn−1, DAn of the audio data packets A1, A2, . . . , An−1, An, are substantially the same as the delays DV1, DV2, . . . , DVn−1, DVn of the video data packets V1, V2, . . . , Vn−1, Vn. Thus, the video and audio data packets can be well-synchronized at playback even with no or little buffering at the receivers.

In reality, the data packets may arrive at the receivers (particularly, the application layer of each of the receivers) with different delays, as shown in FIG. 10B. In FIG. 10B, the delays DA1, DA2, . . . , DAn−1, DAn of the audio data packets A1, A2, An−1, An, are not substantially the same as the delays DV1, DV2, . . . , DVn−1, DVn of the video data packets V1, V2, . . . , Vn−1, Vn. In the context of this document, such a delay difference between multiple data streams can be referred to as an “inter-stream jitter.”

When the data packets DA1-DAn, DV1-DVn contain uncompressed video or audio data, the buffers of the receivers may not provide sufficient buffering to overcome inter-stream jitters because of their limited storage capacities. Thus, at playback, the video and audio data packets can be out of synchronization, degrading the playback quality. Similarly, in embodiments where multiple audio streams are transmitted from a transmitter to multiple audio receivers (e.g., the system shown in FIG. 9B), inter-stream jitters may significantly degrade the playback quality.

In one embodiment, a wireless communication system includes a transmitter, at least one receiver, and a wireless channel between them similar to the ones described above in connection with FIGS. 7 and 9. The wireless communication system is configured to provide synchronization between data packets against intra-stream and/or inter-stream jitters. The wireless system is configured to monitor the propagation of the data packets through at least part of the transmitter, the wireless channel, and the receiver. The system is further configured to determine intra-stream and/or inter-stream jitters based on the results of monitoring the propagation. The system is further configured to re-synchronize the transmission of subsequent data packets from the transmitter if the jitters exceed a predetermined level.

Delays associated with the transmitter, the wireless channel, and the receiver can be described below. Such delays can include a transmission buffering delay Dtb, current packet processing time Tp, and a receiving buffering delay Drb. A total delay Dt in wireless transmission can be a sum of the delays which is represented by Equation 1.

Dt=Dtb+Tp+Drb (1)

The transmission buffering delay Dtb can include two parts: channel time block (CTB) waiting time Dsch and transmission buffering time Dw. The CTB waiting time Dsch refers to waiting time due to the transmission of other streams at the wireless channel. Even if a data packet is ready to be transmitted from a transmission buffer, it may need to wait until the next channel time block (CTB) is scheduled for a stream carrying the data packet. The CTB waiting time Dsch may be represented by Equation 2.

Dsch=K*Tsi (2)

In Equation 2, K is an integer no less than zero (0) and Tsi is the schedule interval time for the stream.

The transmission buffering time Dw is caused by transmission of data packets in the same queue which precede the data packet to be monitored. The transmission buffering time Dw may be represented by Equation 3.

Dw=M*Tp (3)

In Equation 3, M is the number of data packets preceding the data packet to be monitored.

Thus, the transmission buffering delay Dtb can be represented by Equation 4.

Dtb=Dsch+Dw=K*Tsi+M*Tp (4)

The current packet processing time Tp can be represented by Equation 5.

Tp=Lp/Rc (5)

In Equation 5, Lp is a length in bit for each of data packets in a data stream. Rc is a data rate at which the data packets are output from the transmission buffer when channel time is allocated for the stream. In one embodiment, Rc is the same as the effective channel data rate.

The receiving buffering delay Trb can be represented by Equation 6.

Drb=N*Lp/Rs (6)

In Equation 6, N is the number of data packets preceding the packet to be monitored at the receiving buffer. Lp is a length in bit for each of data packets of a data stream. Rs is a data rate at which the data packets are output from the receiving buffer. In one embodiment, Rs is the same as the stream playback data rate.

Therefore, the total delay Dt can be represented by Equation 7.

Dt=K*Tsi+(M+1)*Lp/Rc+N*Lp/Rs (7)

In Equation 7, K, M, N are variables and all others are constants for a stream. M and N are bounded by the transmission and receiving buffer sizes, respectively. If the transmission buffer size is Ltb, M can be represented by Equation 8. If the receiving buffer size is Lrb, N can be represented by Equation 9.

M≦Ltb/Lp−1 (8)

N≦Lrb/Lp−1 (9)

In Equations 8 and 9, Lp is the size of each data packet. In Equation 8, Ltb/Lp represents the total number of data packets that the transmission buffer can store at a given time. “1” was subtracted from Ltb/Lp to provide the number of data packets in the queue which are ahead of the data packet to be monitored. Similarly, in Equation 9, Lrb/Lp represents the total number of data packets that the receiving buffers can store at a given time. “1” was subtracted from Lrb/Lp to provide the number of data packets in the queue which are ahead of the data packet to be detected.

K is bounded by Equation 10 to avoid transmission buffer overflow.

K≦(Ltb−Lp)/(Tsi*Rc) (10)

In Equation 10, Ltb is the transmission buffer size. Lp is the size of each data packet. Tsi is the schedule interval time for the stream. Rc is a data rate at which the data packets are output from the transmission buffer when channel time is allocated for the stream.

The total delay Dt is bounded by a maximum delay Max_Dt as represented by Equation 11.

Dt≦Max_{—}Dt=2*Ltb/Rc−Lp/Rc+(Lrb−Lp)/Rs (11)

In determining an inter-stream jitter, the total delays of two data streams are compared with each other. In an embodiment where there are two streams S1 and S2, it is assumed that the total delay for an S1 packet is Dt1 and the total delay for an S2 packet is Dt2. Then, a jitter value Dj between the S1 packet and the S2 packet can be represented by Equation 12.

Dj=|Dt1−Dt2|≦max{Max_{—}Dt1, Max_{—}Dt2} (12)

A jitter requirement between the two streams S1 and S2 can be represented by Max_Dj. If both Dt1 and Dt2 are less than Max_Dj, the jitter value Dj will be always smaller than Max_Dj, which indicates that the data packets meet the synchronization requirement.

In addition, a re-transmission deadline for a data packet can be represented by Equation 13.

Tdeadline=T0+Max_{—}Dt (13)

In Equation 13, T0 represents time when a data packet is moved from the application layer to the MAC layer of a transmitter.

If the transmission and receiving buffer sizes Ltb and Lrb have been already determined, Equation 11 can be used to estimate the upper limit of the total delay occurring during a wireless transmission. In addition, the upper limits of intra-stream and inter-stream jitters caused at least partly by the transmission buffer can be estimated using Equation 11. If the maximum intra-stream and inter-stream jitters have been determined first, Equation 11 can be used to determine the sizes of the transmission and receiving buffers. In a case where the sizes of the transmission and receiving buffers and an inter-stream jitter have been already determined, if max {Dt1, Dt2} is greater than Max_Dj, extra mechanism may need to be introduced to control the jitter within the range of Max_Dj.

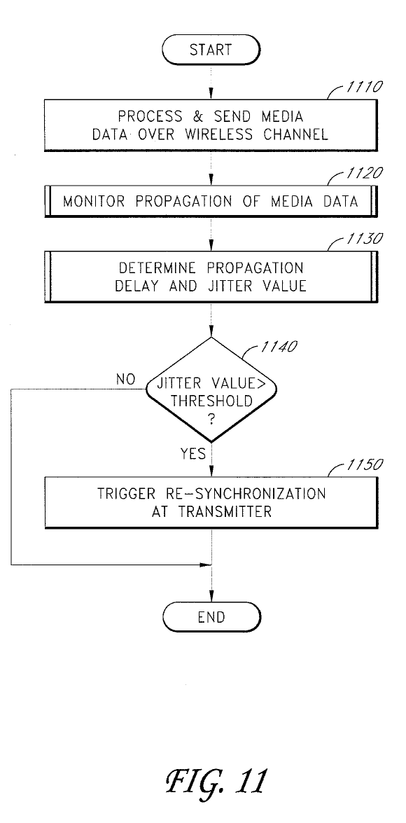

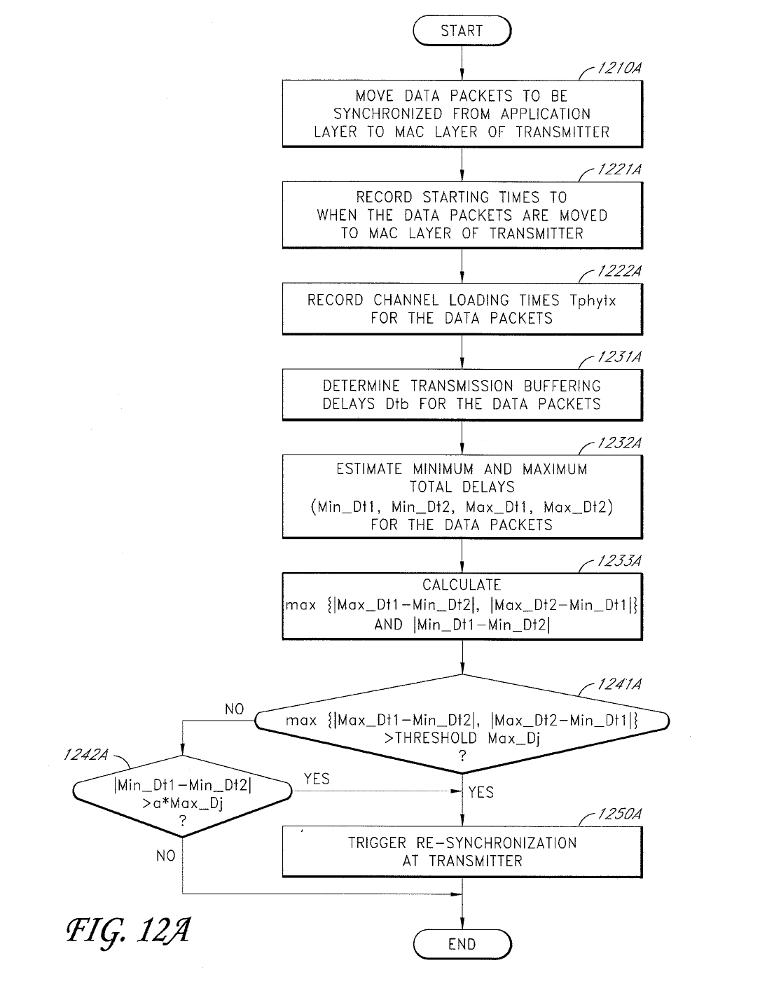

FIG. 11 illustrates a method of synchronizing media data packets according to one embodiment. The method can be used to overcome intra-stream and/or inter-stream jitters. At block 1110, a transmitter starts processing media data (e.g., uncompressed video and/or audio data) for wireless transmission. In one embodiment, the media data processing starts at the application layer of the transmitter. Then, the media data goes through the MAC layer and the PHY layer of the transmitter for further processing. Then, the processed media data is sent to a receiver over a wireless channel. The receiver processes the processed media data back into its original media data at the PHY, MAC, and application layers thereof. The transmitter, the wireless channel, and the receiver form a propagation path for the media data. In one embodiment, the media data travels along the propagation path in a form of data packets.

At block 1120, the propagation of the media data is monitored. In the illustrated embodiment, the media data is packetized into multiple data packets. The data packets to be synchronized can be monitored between two selected points along the propagation path. In some embodiments, the starting point of the two points can be a boundary between the application layer and the MAC layer of the transmitter. In one embodiment, the ending point of the two points can be a boundary between the PHY layer of the transmitter and the wireless channel. In other embodiments, the ending points of the two points can be a boundary between the MAC layer and the application layer of the receiver. It can be detected how long it takes for the data packets to propagate between the two points.

In one embodiment, selected pairs of data packets (e.g., every three pairs of data packets, every five pairs of data packets, every ten pairs of data packets, etc.) are monitored. In another embodiment, all of data packets are monitored.

Then, at block 1130, a propagation delay between the two points is determined for each of the data packets to be synchronized. Then, a jitter value between the data packets to be synchronized is determined by comparing the propagation delays of the data packets to be synchronized. At block 1140, it is determined whether the jitter value exceeds a threshold value. If yes, re-synchronization is triggered at the transmitter at block 1150. If not, the process is terminated without triggering re-synchronization. In certain embodiments, after waiting for a predetermined period of time, the entire process may be repeated.

At block 1150, the re-synchronization process is performed. Among multiple data streams, one of the streams can be a master stream, and the other streams can be slave streams. For example, for an audio stream and a video stream, the audio stream can be a master stream and the video stream can be a slave stream. Slave streams are synchronized to a master stream by delaying or speeding.

In one embodiment, a stream can be sped up by preventing re-transmission temporally at reserved CTBs. Re-transmission can be conducted at unreserved CTB with possible contention with other transmissions. In another embodiment, a stream at a MAC layer can be sped up by skipping some pixel partitions (packetized into video subpixels) at the transmitter. Then, the skipped pixel partitions can be re-constructed at the receiver side by copying from neighboring pixel partitions. In yet another embodiment, at the application level, information copying and skipping (at the video frame and pixel level) can be used to reduce jitters between two streams.

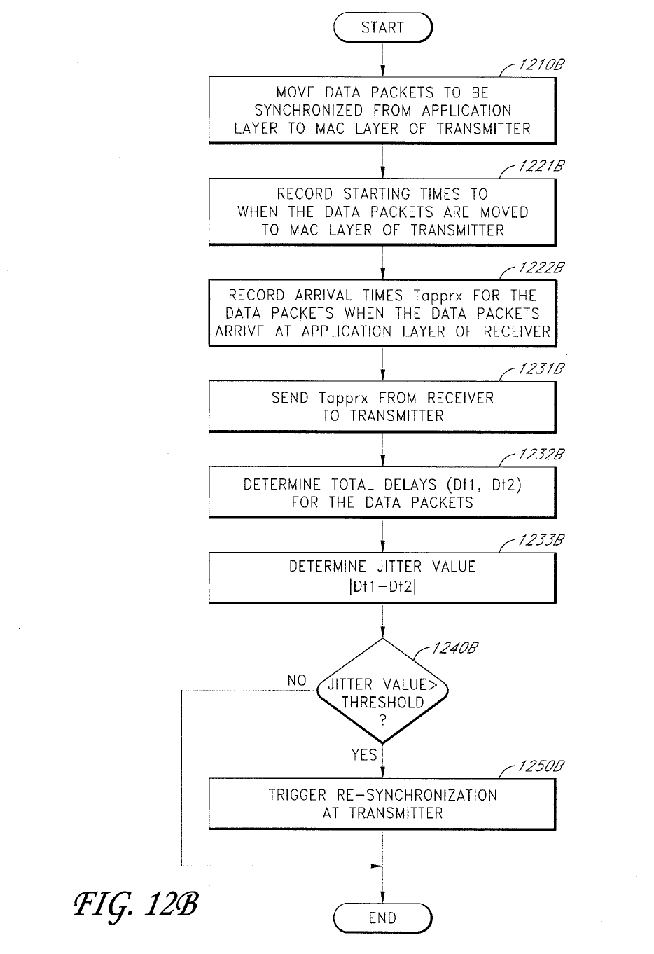

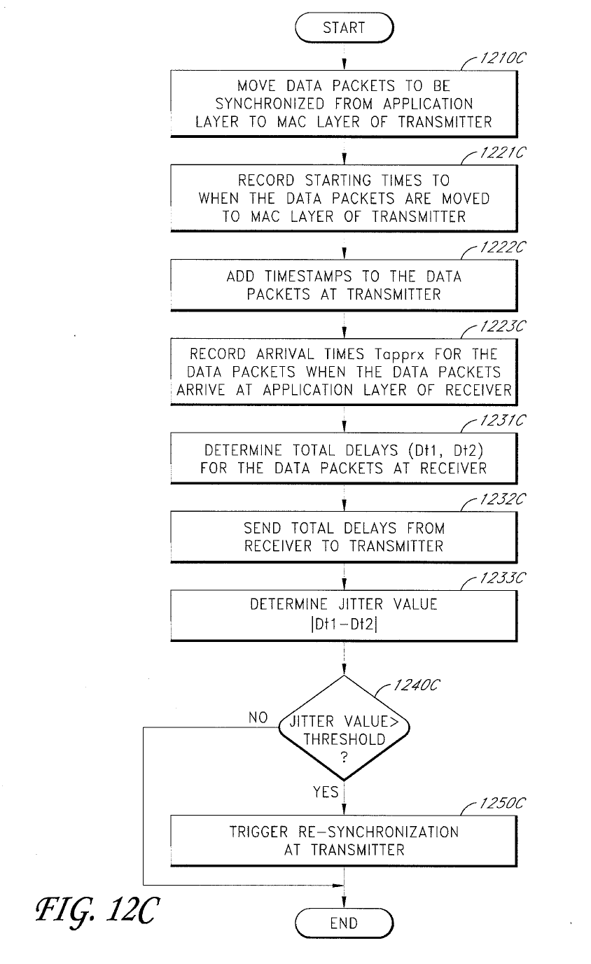

FIG. 12A illustrates a method of synchronizing data packet transmission over a wireless channel, according to another embodiment. In the illustrated embodiment, media data is moved along the propagation path described above in connection with block 1110 of FIG. 11. The media data can be packetized into multiple data packets at the application layer of the transmitter. Then, at block 1210A, the data packets to be synchronized are moved from the application layer to the MAC layer of the transmitter. The data packets can include audio and/or video data packets. The data packets to be synchronized can be in a single data stream (in an embodiment for intra-stream synchronization) or multiple data streams (in an embodiment for inter-stream synchronization).

Then, the propagation of the data packets to be synchronized is monitored. In the illustrated embodiment, at block 1221A, a starting time T0 for each of the data packets to be synchronized is recorded when the data packets are moved from the application layer to the MAC layer of the transmitter. At block 1222A, a channel loading time Tphytx for each of the data packets is recorded. The channel loading time refers to a time when a data packet is put on a wireless channel. For example, the channel loading time Tphytx can be when the last bit of a data packet is put on a wireless channel.

At block 1231A, a transmission buffering delay Dtb of each of the data packets to be synchronized is determined. The transmission buffering delay Dtb can be as described above with respect to Equation 4. In the illustrated embodiment, the transmission buffering delay can be measured as a time difference between the channel loading time Tphytx and the starting time T0, as shown in Equation 14.

Dtb=Tphytx−T0 (14)

At block 1232A, the maximum and minimum total delays Min_Dt and Max_Dt of each of the data packets to be synchronized are estimated. Referring back to Equation 1, the transmission buffering delay and the current packet processing time Tp are now known while the receiving buffering delay Drb is not known. The minimum and maximum total delays Min_Dt and Max_Dt are represented by Equation 15.

Min_{—}Dt=Dtb+Tp=Dtb+Lp/Rc≦Dt≦Max_{—}Dt=Dtb+Lrb/Rs+Lp/Rs−Lp/Rs (15)

In one embodiment in which there are first and second data streams S1 and S2 to be synchronized, the total delay for an S1 data packet in the first data stream S1 is Dt1 and the total delay for an S2 data packet in the second data stream S2 is Dt2. At block 1233A, for the two data packets to be synchronized, a difference between the minimum total delays of the data packets, |Min_Dt1−Min_Dt2|, is determined. In addition, a maximum of |Max_Dt1−Min Dt2| and |Max_Dt2−Min_Dt1| is determined.

A jitter value Dj between the S1 and S2 data packets can be bounded by Equation 16-1.

|Min_{—}Dt1−Min_{—}Dt2|≦Dj≦max{|Max_{—}Dt1-Min_{—}Dt2|,|Max_Dt2−Min_Dt1|} (16-1)

Dj=|Dt1−Dt2| (16-2)

In the illustrated embodiment, a jitter threshold or requirement between the two streams S1 and S2 is Max_Dj. At block 1241A, it is determined whether max{|Max_Dt1−Min_Dt2|, |Max_Dt2−Min_Dt1|}is greater than the jitter requirement Max_Dj. If yes, re-synchronization is triggered at block 1250A. If not, the process goes to block 1242A. At block 1242A, it is determined whether |Min_Dt1−Min_Dt2| is greater than the jitter requirement Max_Dj multiplied by “a” (for example, 0.5<a<1). If yes, re-synchronization is triggered at block 1250A. If not, the process is terminated without re-synchronization. The re-synchronization process can be as described above with respect to block 1150 of FIG. 11.

FIG. 12B illustrates a method of synchronizing data packet transmission over a wireless channel, according to another embodiment. Media data is moved along the propagation path described above in connection with block 1110 of FIG. 11. The media data can be packetized into multiple data packets at the application layer of the transmitter. Then, the data packets to be synchronized are moved from the application layer to the MAC layer of the transmitter. The data packets to be synchronized can be in a single data stream or multiple data streams. The data packets can include audio and/or video data packets. In the illustrated embodiment, reference clocks at the transmitter and the receiver are substantially in synchronization with each other.

Then, the propagation of the data packets is monitored. In the illustrated embodiment, at block 1221B, a starting time T0 for each of the data packets to be synchronized is recorded when the data packet is moved from the application layer to the MAC layer of the transmitter. The data packets go through the MAC and PHY layers of the transmitter, and then travel over a wireless channel. The data packets then arrive at the PHY layer of the receiver. Within the receiver, the data packets go through the PHY layer, the MAC layer, and the application layer of the receiver. An arriving time Tapprx for each of the data packets to be synchronized is recorded when the data packet arrives at the application layer of the receiver at block 1222B.

At block 1231B, the receiver sends a signal indicative of the arriving time Tapprx to the transmitter. At block 1232B, the transmitter determines a total delay for each of the data packets to be synchronized. The total delay Dt can be represented by Tapprx−T0. In the illustrated embodiment, the total delays Dt1, Dt2 of two data packets to be synchronized are determined based on the starting times T01, T02 and the arriving times Tapprx1, Tapprx2 of the data packets. Then, for the two packets, a jitter value is calculated as |Dt1−Dt2| at block 1233B.

Subsequently, at block 1240B, it is determined whether the jitter value between the two data packets exceeds a predetermined threshold value, Max_Dj. If yes, re-synchronization is triggered at block 1250B. If not, the process is terminated without re-synchronization.

FIG. 12C illustrates a method of synchronizing data packet transmission over a wireless channel, according to yet another embodiment. Media data is moved along the propagation path described above in connection with block 1110 of FIG. 11. The media data can be packetized into multiple data packets at the application layer of the transmitter. At block 1210C, the data packets to be synchronized are moved from the application layer to the MAC layer of the transmitter. The data packets to be synchronized can be in a single data stream or multiple data streams. The data packets can include audio and/or video data packets. In this embodiment, reference clocks at the transmitter and the receiver are in synchronization with each other.

In the illustrated embodiment, at block 1221C, a starting time T0 for each of the data packets to be synchronized is recorded at the transmitter when the data packet is moved from the application layer to the MAC layer of the transmitter. At block 1222C, a time stamp indicating the starting time T0 is added to each of the data packets to be synchronized. The data packets go through the MAC and PHY layers of the transmitter, and then travel over a wireless channel. Then, the data packets arrive at the PHY layer of the receiver. Within the receiver, the data packets go through the PHY layer, the MAC layer, and the application layer of the receiver. An arriving time Tapprx is recorded when each of the data packets arrives at the application layer of the receiver at block 1223C.

At block 1231C, the receiver determines a total delay Dt between the starting time T0 and the arriving time Tapprx for each of the data packets. In determining the total delay Dt, the receiver can use the time stamp (indicating T0) and the recorded arriving time Tapprx. In the illustrated embodiment, the total delays Dt1, Dt2 of two data packets to be synchronized are determined at block 1231C. Then, the receiver sends a signal indicative of the delays Dt1, Dt2 to the transmitter at block 1232C. In certain embodiments, the receiver is configured to send the signal indicative of the delays Dt1, Dt2 to the transmitter only when the delays exceed a threshold value. In other embodiments, the receiver can send the signal to the transmitter at a selected interval, for example, every several (three, five, ten, fifteen, . . . , etc.) data packets.

At block 1233C, the transmitter determines a jitter value based on the delays Dt1, Dt2. For the two data packets to be synchronized, the jitter value can be represented as |Dt1−Dt2|.

Subsequently, at block 1240C, it is determined whether the jitter value between the two data packets exceeds a predetermined threshold value, Max_Dj. If yes, re-synchronization is triggered at block 1250C. If not, the process is terminated without re-synchronization.

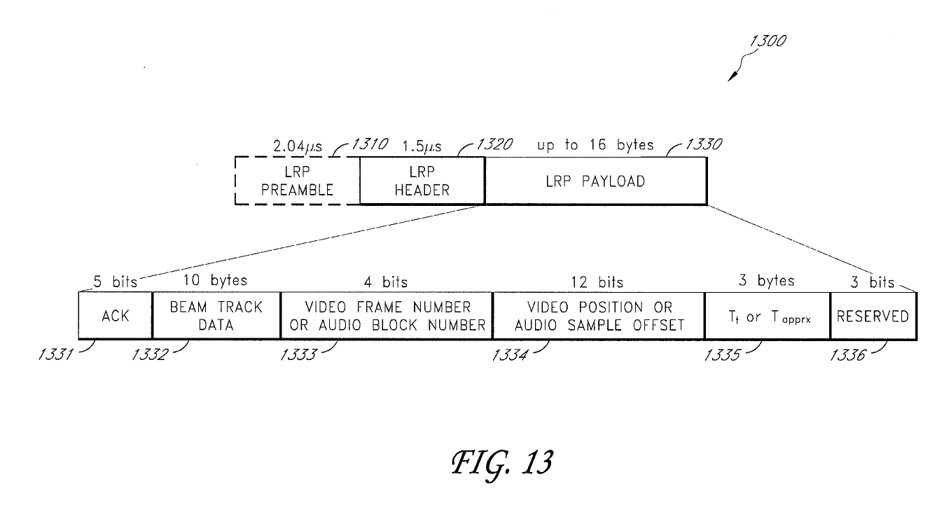

FIG. 13 is a timeline of one embodiment of acknowledgment (ACK) signal for carrying data indicative of the propagation information of a data packet. The illustrated ACK signal 1300 includes a low-rate PHY (LRP) preamble 1310, LRP header 1320, and LRP payload 1330. It will be appreciated that various other ACK frames are also possible. It will also be appreciated that a non-ACK control signal can also be used to carry the propagation information.

The LRP preamble 1310 is used for synchronizing the transmitter and the receiver so that the receiver can correctly receive the ACK signal. The LRP preamble 1310 can have a length which depends upon the physical (PHY) layer technology and the transmission mode. The transmission mode can be omni-directional or directional mode as described above. In the omni-directional mode, the LRP preamble 1310 may last about 35 μs to about 70 μs, optionally about 60 μs. In the directional mode, the LRP preamble 1310 may last about 2 μs to about 4 μs. It will be appreciated that the duration of the LRP preamble 1310 can vary widely depending on the design of the ACK frame format.

The LRP header 1320 can include various information and format. The format of the LRP header may depend on the ACK type such as directional acknowledgment (D-ACK) or omni-directional acknowledgment (O-ACK). In one embodiment, the LRP header 1320 includes multi-bit data sequence. Each bit in the sequence may include different information, depending on whether the system uses D-ACK or O-ACK.

The LRP payload 1330 can include an acknowledgment (ACK) field 1331, a beam track data field 1332, a video frame/audio block number field 1333, a video position/audio sample offset field 1334, a propagation information field 1335, and a reserved field 1336. The ACK field 1331 can include data indicative of the receipt of a data packet. The beam track data field 1332 includes data indicative of the status of beam-forming between the transmitter and receiver. The video frame/audio block number field 1333 and video position/audio sample offset field 1334 serve to indicate for which video/audio portion the propagation information field 1335 carries propagation information. The propagation information field 1335 can include data indicative of a propagation delay of a packet as described above in the embodiments above. For example, the data can be indicative of an arriving time Tapprx (for the embodiment shown in FIG. 12B) or a total delay Dt (for the embodiment shown in FIG. 12C). The propagation information field 1335 can include 3 bytes. In other embodiments, propagation information can be separately transmitted in reserved CTB or unreserved CTB at low-rate PHY without being combined with an ACK signal.

In the systems and methods of the embodiments described above, the transmission of media data packets is adjusted at the transmitter based on the determination of a jitter between media data packets. This configuration allows effective playback synchronization of media data at sink devices which have a limited buffering capacity for uncompressed media data.

In addition, the detection of the propagation of data packets does not significantly add to the wireless channel traffic. In one embodiment shown in FIG. 12A, the detection is conducted only within the transmitter. In the other embodiments shown in FIGS. 12B and 12C, the receiver sends only a small amount of data indicative of the arriving time or propagation delay to the transmitter over the wireless channel.

The foregoing description is that of embodiments of the invention and various changes, modifications, combinations and sub-combinations may be made without departing from the spirit and scope of the invention, as defined by the appended claims.

What is claimed is:

1. A method of wireless communication of uncompressed media data, the method comprising:
transmitting media data packets from a source such that they propagate over a wireless channel, the media data packets being spaced apart from one another by at least one interleaved time;
detecting propagation of at least two of the media data packets;
determining propagation delays of the at least two media data packets;
determining a jitter value between the at least two media data packets based on the determined propagation delays; and
adjusting the transmission of subsequent media data packets from the source at least partly in response to the determination of the jitter value.

2. The method of claim 1, wherein the media data comprises at least one of audio data and video data.

3. The method of claim 2, wherein the video data comprises data for displaying at least one of moving images, still images, animation, and graphic images.

4. The method of claim 1, wherein the media data packets are transmitted in a single data stream from the source to a sink over the wireless channel, and wherein determining the jitter value comprises determining a variance in the propagation delays between the media data packets in the single data stream.

5. The method of claim 1, wherein the media data packets are transmitted in at least two data streams from the source to at least one sink, and wherein determining the jitter value comprises determining a variance in the propagation delays between the media data packets in the at least two data streams.

6. The method of claim 5, wherein the at least two data streams comprise a video data stream and an audio data stream, and wherein the at least one sink comprises a video sink configured to receive the video data stream and an audio sink configured to receive the audio data stream.

7. The method of claim 5, wherein the at least two data streams comprise a plurality of audio data streams, and wherein the at least one sink comprises a plurality of audio sinks, each configured to receive a corresponding one of the audio data streams.

8. The method of claim 5, wherein one of the at least two data streams is a master stream and the others of the at least two data streams are slave streams, and wherein adjusting the transmission of the subsequent media data packets comprises synchronizing the slave streams to the master stream.

9. The method of claim 1, wherein the source comprises a transmitter configured to process the media data packets and to send the media data packets over the wireless channel,
wherein the sink comprises a receiver configured to receive the media data packets over the wireless channel and to process the received media data packets, and
wherein detecting the propagation of the at least two media data packets comprises detecting the propagation of the at least two media data packets while the at least two media data packets propagate through at least part of the transmitter, the wireless channel, and the receiver.

10. The method of claim 9, wherein the transmitter comprises an application layer, a media access control (MAC) layer, and a physical (PHY) layer, and wherein detecting the propagation of the at least two media data packets comprises detecting a first time when each of the at least two media data packets is moved from the transmitter application layer to the transmitter MAC layer.

11. The method of claim 10, wherein detecting the propagation of the at least two media data packets further comprises detecting a second time when each of the at least two media data packets is moved from the PHY layer to the wireless channel.

12. The method of claim 11, wherein determining the propagation delays comprises determining a time difference between the first and second times for each of the at least two media data packets.

13. The method of claim 10, wherein the receiver comprises a physical (PHY) layer, a media access control (MAC) layer, and an application layer, and wherein detecting the propagation of the at least two media data packets further comprises detecting a second time when each of the at least two media data packets is moved from the receiver MAC layer to the receiver application layer.

14. The method of claim 13, further comprising sending data indicative of the second time from the receiver to the transmitter such that the propagation delays are determined at the transmitter.

15. The method of claim 14, wherein sending the data indicative of the second time comprises sending an acknowledgment signal from the receiver to the transmitter, and wherein the acknowledgment signal includes the data indicative of the second time.

16. The method of claim 13, further comprising adding a time stamp indicative of the first time to each of the at least two media data packets at the transmitter before the data packets are transmitted to the receiver, wherein the propagation delays are determined at the receiver using the time stamp, and wherein the method further comprises sending data indicative of the propagation delays from the receiver to the transmitter.

17. The method of claim 16, wherein sending the data indicative of the propagation delays comprises sending an acknowledgment signal from the receiver to the transmitter, and wherein the acknowledgment signal includes the data indicative of the propagation delays.

18. The method of claim 16, wherein sending the data indicative of the propagation delays comprises selectively sending the data indicative of the propagation delays only when the propagation delays exceed a threshold value.

19. The method of claim 1, wherein the jitter value is determined at the source.

20. The method of claim 1, wherein adjusting the transmission of the subsequent media data packets comprises re-synchronizing the subsequent media data packets if the jitter value exceeds a predetermined value.

21. A method of wireless communication of uncompressed media data, the method comprising:
receiving media data packets at a receiver over a wireless channel from a transmitter, the media data packets being spaced apart from one another by at least one interleaved time;
processing the media data packets to recover media data;
detecting propagation of at least two of the media data packets for determining propagation delays of the media data packets; and
sending data indicative of the propagation delays of the at least two media data packets from the receiver over the wireless channel to the transmitter.

22. The method of claim 21, wherein the receiver comprises a physical (PHY) layer, a media access control (MAC) layer, and an application layer, and wherein detecting propagation of the at least two media data packets comprises detecting an arriving time when each of the at least two media data packets is moved from the MAC layer to the application layer.

23. The method of claim 22, wherein the data is indicative of the arriving time.

24. The method of claim 22, wherein the at least two media data packets include time stamps indicative of the starting time of the propagation of the at least two data packets, and wherein the method further comprises determining the propagation delays using the time stamps.

25. A wireless communication system for uncompressed media data comprising:
a source configured to transmit media data packets such that they propagate over a wireless channel, the media data packets being spaced apart from one another by at least one interleaved time; and
at least one sink configured to receive the media data packets over the wireless channel from the source,
wherein at least one of the source and the at least one sink is configured to detect propagation of at least two of the media data packets, and to determine propagation delays of the at least two media data packets,
wherein the source is configured to determine a jitter value between the at least two media data packets based on the determined propagation delays, and
wherein the source is further configured to adjust the transmission of subsequent media data packets at least partly based on the jitter value.

26. The system of claim 25, wherein the source comprises a transmitter configured to transmit the media data packets in a single data stream, and wherein the source is configured to determine the jitter value by determining a variance in the propagation delays between the media data packets in the single data stream.

27. The system of claim 25, wherein the source comprises a transmitter configured to transmit the media data packets in at least two data streams, and wherein the source is configured to determine the jitter value by determining a variance in the propagation delays between the media data packets in the at least two data streams.

28. The system of claim 25, wherein the source comprises a transmitter configured to process the media data packets and to send the media data packets over the wireless channel,
wherein the at least one sink comprises a receiver configured to receive the media data packets over the wireless channel and to process the received media data packets, and
wherein the system is configured to detect the propagation of the at least two media data packets while the media data packets propagate through at least part of the transmitter, the wireless channel, and the receiver.

29. The system of claim 28, wherein the transmitter comprises an application layer, a media access control (MAC) layer, and a physical (PHY) layer, and wherein the transmitter is configured to detect a first time when each of the at least two media data packets is moved from the transmitter application layer to the transmitter MAC layer.

30. The system of claim 29, wherein the transmitter is further configured to detect a second time when each of the at least two media data packets is moved from the transmitter PHY layer to the wireless channel.

31. The system of claim 30, wherein the transmitter is further configured to determine a time difference between the first and second times for each of the at least two media data packets, thereby determining the propagation delays.

32. The system of claim 29, wherein the receiver comprises a physical (PHY) layer, a media access control (MAC) layer, and an application layer, and wherein the receiver is configured to detect a second time when each of the at least two media data packets is moved from the receiver MAC layer to the receiver application layer.

33. The system of claim 32, wherein the receiver is further configured to send data indicative of the second time to the transmitter, and wherein the transmitter is further configured to determine the propagation delays.

34. The system of claim 33, wherein the receiver is further configured to send an acknowledgment signal to the transmitter, and wherein the acknowledgment signal includes the data indicative of the second time.

35. The system of claim 32, wherein the transmitter is further configured to add a time stamp indicative of the first time to each of the at least two media data packets before the data packets are transmitted to the receiver, wherein the receiver is further configured to determine the propagation delays using the time stamp, and to send data indicative of the propagation delays to the transmitter.

36. The system of claim 35, wherein the receiver is further configured to send an acknowledgment signal to the transmitter, and wherein the acknowledgment signal includes the data indicative of the propagation delays.

37. The system of claim 35, wherein the receiver is further configured to selectively send the data indicative of the propagation delays only when the propagation delays exceed a threshold value.

38. The system of claim 25, wherein the source is configured to re-synchronize subsequent media data packets if the jitter value exceeds a predetermined value.

39. A wireless communication device for transmitting uncompressed media data, the device comprising:
a transmitter configured to process media data to generate media data packets which are spaced apart from one another by at least one interleaved time, and transmit the media data packets such that they propagate over a wireless channel;
wherein the transmitter is further configured to at least partially detect propagation of at least two of the media data packets to determine propagation delays of the media data packets; and
wherein the transmitter is further configured to determine a jitter value between the at least two media data packets based on the determined propagation delays, and to adjust the transmission of subsequent media data packets at least partly in response to the determination of the jitter value.

40. The device of claim 39, wherein the transmitter comprises an application layer, a media access control (MAC) layer, and a physical (PHY) layer, and wherein the transmitter is configured to detect a first time when each of the at least two media data packets is moved from the transmitter application layer into the transmitter MAC layer.

41. The device of claim 40, wherein the transmitter is further configured to detect a second time at the transmitter when each of the at least two media data packets is moved from the PHY layer to the wireless channel.

42. A wireless communication device for receiving uncompressed media data, the device comprising:
a receiver configured to receive media data packets which are spaced apart from one another by at least one interleaved time over a wireless channel from a transmitter, and to process the media data packets to recover media data;
wherein the receiver is further configured to at least partially detect propagation of at least two of the media data packets for determining propagation delays of the media data packets; and
wherein the receiver is further configured to send data indicative of the propagation delays of the at least two media data packets over the wireless channel to the transmitter.

43. The device of claim 42, wherein the receiver comprises a physical (PHY) layer, a media access control (MAC) layer, and an application layer, and wherein the receiver is configured to detect an arriving time when each of the at least two media data packets is moved from the MAC layer to the application layer.

44. The device of claim 43, wherein the data is indicative of the arriving time.

45. The device of claim 43, wherein the at least two media data packets include time stamps indicative of the starting time of the propagation of the at least two data packets, and wherein the receiver is further configured to determine the propagation delays using the time stamps, and to send data indicative of the propagation delays to the transmitter.
